(19) United States
(12) Patent Application Publication
(10) Pub. No.: US 2016/0212232 A1
(43) Pub. Date: Jul. 21, 2016

(54) SOCIAL MUSIC SYSTEM

(71) Applicant: Michael Lansky, Sydney (AU)

(72) Inventor: Michael Lansky, Sydney (AU)

(21) Appl. No.: 14/601,229

(22) Filed: Jan. 21, 2015

(51) Int. Cl. H04L 29/08; G06Q 30/06; G06Q 50/00

(52) U.S. Cl. CPC H04L 67/22; G06Q 50/01; G06Q 30/0601

(57) ABSTRACT

A system and method for interactive music, including: an online music store for holding an inventory of original songs, the online music store enabling a set of social music clients to access the original songs and generate a set of social versions of the original songs; a social music repository for holding an inventory of the social versions, the social music repository enabling the social music clients to post the social versions and access the posted social versions; and an ownership registry for holding a set of ownership information for each social version in the social version repository such that the ownership information enables allocation of ownership among a set of original artists of the original songs and a set of users of the social music clients.

### BACKGROUND

A music player can enable a user to playback songs purchased on an on-line music store. For example, personal computers, portable devices, smartphones, tablets, etc., can enable a user to purchase songs from an on-line store, and download and play the songs. A purchased song from an on-line music store can include a pair of stereo tracks for playback on stereo speakers. A music player can store purchased songs in a local music library on the music player and provide a user interface that enables a user to select songs and playlists for playback.

### SUMMARY

In general, in one aspect, the invention relates to a social music system. The system can include: an online music store for holding an inventory of original songs, the online music store enabling a set of social music clients to access the original songs and generate a set of social versions of the original songs; a social music repository for holding an inventory of the social versions, the social music repository enabling the social music clients to post the social versions and access the posted social versions; and an ownership registry for holding a set of ownership information for each social version in the social version repository such that the ownership information enables allocation of ownership among a set of original artists of the original songs and a set of users of the social music clients.

In general, in another aspect, the invention relates to a social music client. The social music client can include: a song library for holding a first original song obtained from an online music store; an interactive music module that enables a user to generate a social version of the first original song by creating a set of user content for the social version in response to a set of original content of the first original song; and a repository client that enables the user to post the social version of the first original song to a social music repository.

In general, in another aspect, the invention relates to a method for social music. The method can include: providing an inventory of original songs including a first original song; providing a social music repository for holding an inventory of social versions of the original songs; accessing the first original song from the inventory of original songs; generating a first social version of the first original song; and posting the first social version to the social music repository.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a social music system including an online music store, a social music repository, and a set of social music clients, in accordance with one or more embodiments.

FIG. 2 shows a user of a social music client obtaining an original song from the online music store and posting a social version of the original song to the social music repository, in accordance with one or more embodiments.

FIG. 3 shows a user of a social music client obtaining the social version of the original song from the social music repository and posting another social version of the original song back into the social music repository, in accordance with one or more embodiments.

FIG. 4 illustrates a social music client, in accordance with one or more embodiments.

FIG. 5A illustrates a variety of components of an original song, in accordance with one or more embodiments.

FIG. 5B shows a user interface that enables a user to quickly set up a custom accompaniment for recording a user track for inclusion in a social version of an original song, in accordance with one or more embodiments.

FIG. 6 illustrates a social music client recording a user track with a custom accompaniment selected by the user, in accordance with one or more embodiments.

FIGS. 7A-7C illustrate an example set of guitar effects including volume, pitch, and reverb parameters, in accordance with one or more embodiments.

FIG. 8 shows examples of learning cues provided on a display of a social music client, in accordance with one or more embodiments.

FIG. 9 shows a storyboard for a user interface of the social music client that enables a user to create a custom mix, in accordance with one or more embodiments.

FIG. 10 shows communication between a social music client and the social music repository, in accordance with one or more embodiments.

FIG. 11 illustrates a method for social music, in accordance with one or more embodiments.

FIG. 12 shows elements of a computing system for a social music system, in accordance with one or more embodiments.

FIG. 13 illustrates a main menu of a social music client that enables a user to access a variety of interactive and social music functions, in accordance with one or more embodiments.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

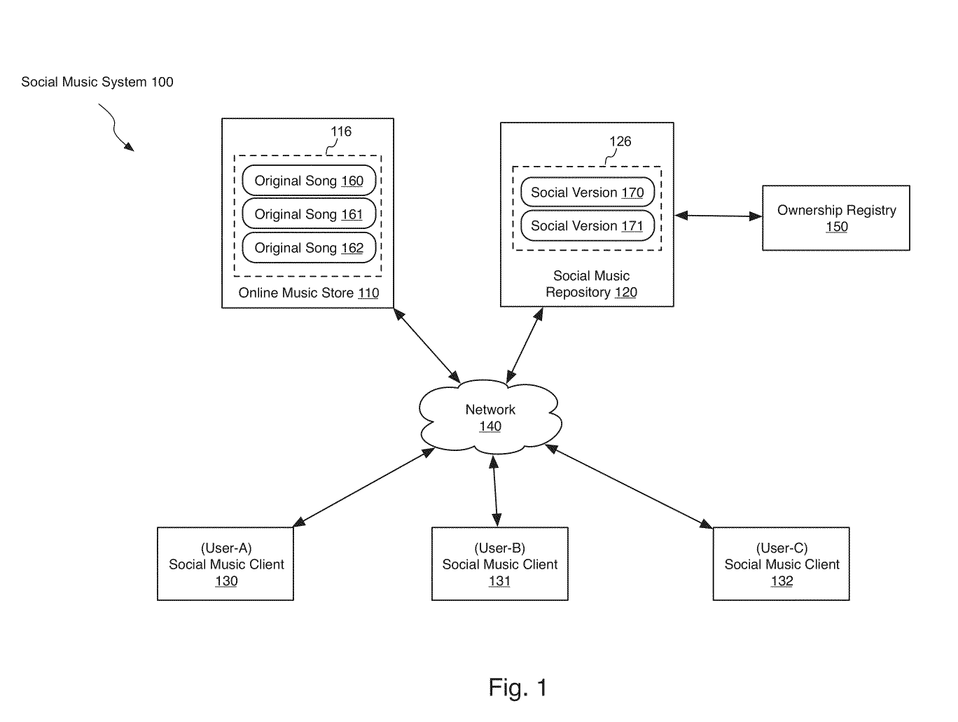

FIG. 1 illustrates a social music system 100, in accordance with one or more embodiments. The social music system 100 may include an online music store 110 for holding an inventory 116 of original songs, e.g., a set of original songs 160-162. The social music system 100 may include a social music repository 120 for holding an inventory 126 of social versions of one or more of the original songs in the inventory 116, e.g. a social version 170 of the original song 160 and a social version 171 or the original song 160.

The social music system 100 may include a set of social music clients 130-132 that enable a set of corresponding users (User-A, User-B, and User-C) to obtain original songs from the online music store 110 and generate social versions in response to the obtained original songs and post the social versions to the social music repository 120. For example, the social music client 130 enables the User-A to obtain the original song 160 from the online music store 110 and generate the social version 170 in response to the obtained original song 160 and then post the social version 170 to the social music repository 120.

The social music clients 130-132 may also enable the corresponding users to obtain social versions from the social music repository 120 and generate additional social versions in response to the obtained social versions and post the additional social versions to the social music repository 120. For example, the social music client 131 enables the User-B to obtain the social version 170 from the social music repository 120 and generate the social version 171 in response to the obtained social version 170 and then post the social version 171 to the social music repository 120.

In one or more embodiments, the social music clients 130-132 access the online music store 110 and the social music repository 120 via a network 140. The social music clients 130-132, the online music store 110, and the social music repository 120 can communicate using Internet protocols. There can be any number of social music clients of the online music store 110 and the social music repository 120.

The social music clients 130-132 can be embodied in personal computers, mobile devices, game consoles, etc., or any combination thereof. For example, the social music clients 130-132 can be application programs, mobile device apps, web apps, etc.

The social music system 100 may include an ownership registry 150 for holding a set of ownership information for each social version in the social music repository 120. The ownership registry 150 can be integrated with the social music repository 120, the online music store 110, or can be a separate service accessible via the network 140.

The online music store 110 and the social music repository 120 can be separate services on separate servers or can be implemented on the same server or website. In some embodiments, the inventory 126 can be accessed via the same store interface used by the social music clients 130-132 to access the inventory 116.

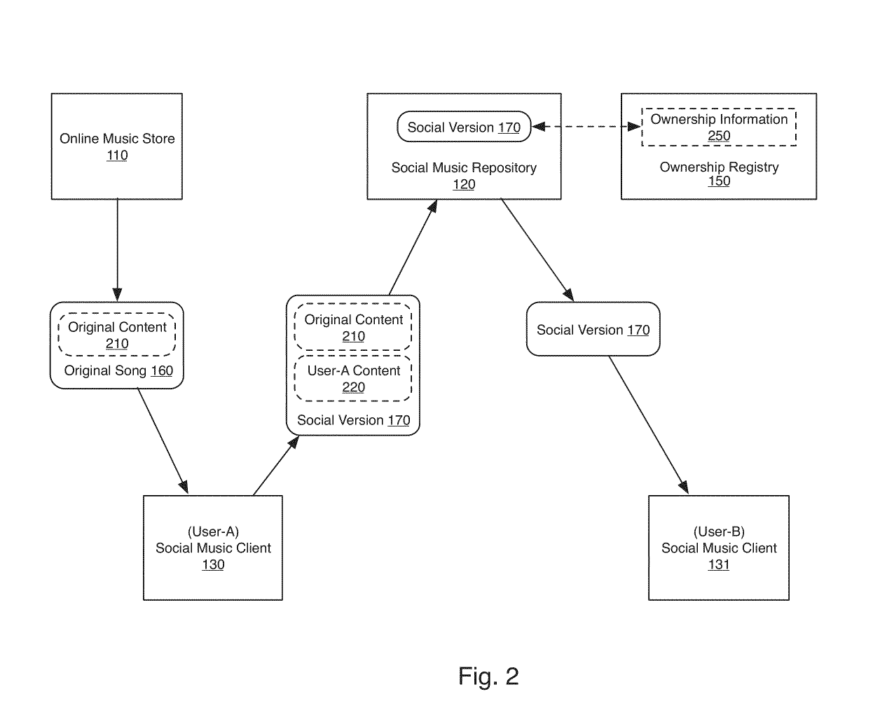

FIG. 2 shows the User-A of the social music client 130 obtaining the original song 160 from the online music store 110 and posting the social version 170 of the original song 160 to the social music repository 120, in accordance with one or more embodiments. The original song 160 includes a set of original content 210. The social version 170 includes the original content 210 and a set of User-A content 220 created by the User-A of the social music client 130.

The User-A content 220 can be any content created by the User-A for the social version 170 in response to the original content 210. For example, the User-A content 220 can be a lead guitar track or backup vocals track created by the User-A. The User-A content 220 can include lyrics, effects, instructional videos, album cover art, mixing/production information, written music, productions rights, etc.

In one or more embodiments, the social music repository 120 updates the ownership registry 150 with a set of ownership information 250 in response to the posting of the social version 170 by the User-A. The ownership information 250 can include an ownership identifier for the original content 210 of the social version 170 that identifies an owner of the original content 210, e.g. an original artist, producer, record label, etc. The ownership information 250 can include an ownership identifier for the User-A content 220 of the social version 170 that identifies the User-A as an owner. The ownership information 250 can provide a register of intellectual property rights in the social version 170.

The ownership information 250 can enable an allocation of pecuniary remuneration associated with the social version 170. For example, the User-B can use the social music client 131 to obtain the social version 170 from the social music repository 120, e.g., by purchase or streaming via the network 140. The social music repository 120 can use the ownership information 250 to allocate revenue obtained from the User-B among the owners identified by the ownership information 250. Any formula can be applied to the ownership information 250 when determining allocation of funds received from the User-B.

In one or more embodiments, the social music clients 130-132 enable the corresponding users, the User-A, the User-B, and the User-C, respectively, to access the social versions from the social music repository 120 and generate additional social versions in response to the obtained social versions and then post the additional social versions to the social music repository 120. For example, the User-B uses the social music client 131 to obtain the social version 170 from the social music repository 120, generate the social version 171 in response to the obtained social version 170, and then post the social version 171 to the social music repository 120.

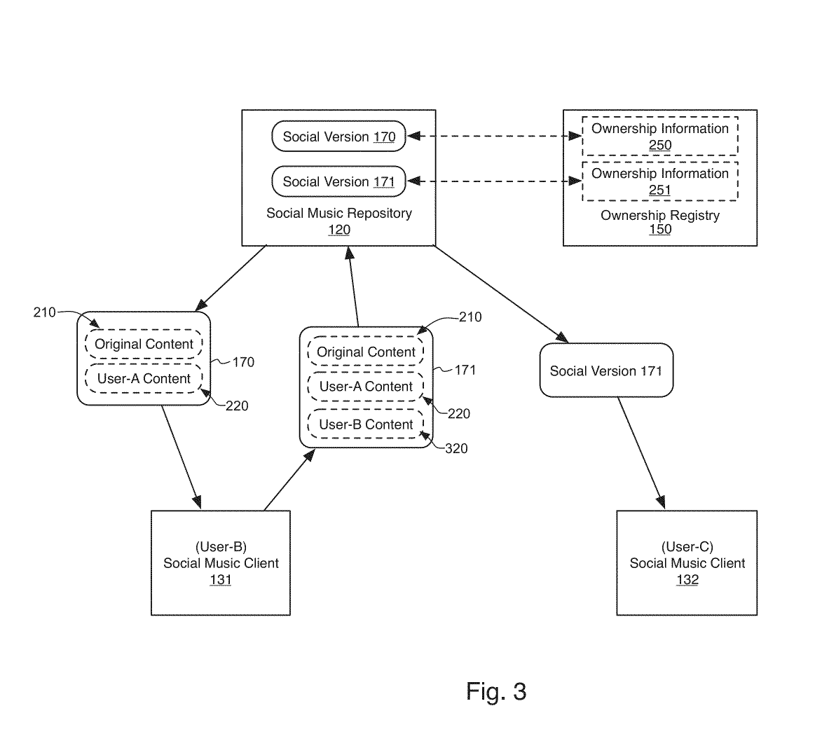

FIG. 3 shows the User-B of the social music client 131 obtaining the social version 170, including the original content 210 and the User-A content 220, from the social music repository 120 and posting the social version 171 to the social music repository 120, in accordance with one or more embodiments. The social version 171 in this example includes the original content 210 from the social version 170, the User-A content 220 from the social version 170, and a set of User-B content 320 provided by the User-B of the social music client 131.

In one or more embodiments, the social music repository 120 updates the ownership registry 150 with a set of ownership information 251 in response to the posting of the social version 171 by the User-B. The ownership information 251 can include the ownership identifiers for the original content 210 and the ownership identifiers for the User-A content 220 (discussed above) and one or more ownership identifiers for the User-B content 320. The User-C, for example, can use the social music client 132 to obtain the social version 171 from the social music repository 120 (e.g., by purchase or streaming via the network 140) and the social music repository 120 can use the ownership information 251 to allocate revenue obtained from the User-C among (e.g., an original artist, the User-A, and the User-B).

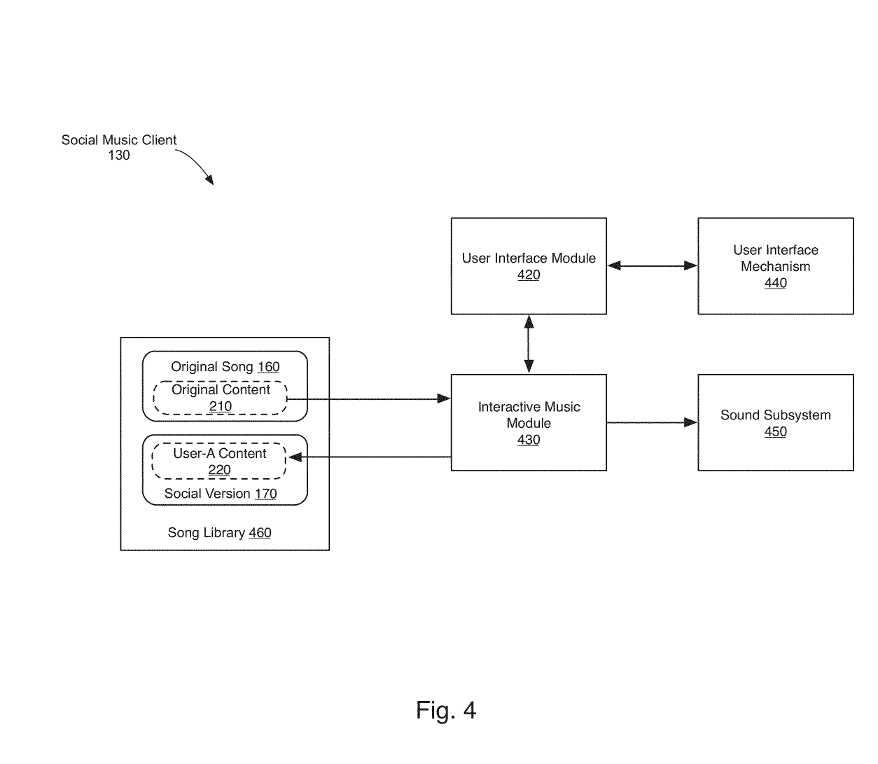

FIG. 4 illustrates the social music client 130, in accordance with one or more embodiments. The social music client 130 includes a song library 460 belonging to the User-A. The song library 460 in this example holds the original song 160 obtained by the User-A from the online music store 110, along with the social version 170 generated by the User-A. The song library 460 can also hold content created by the User-A as standalone items, e.g. music tracks generated by the User-A.

The social music client 130 can include an interactive music module 430 that enables the User-A to perform a variety of interactive/social music functions using content in the song library 460. For example, the interactive music module 430 enables the User-A to generate the social version 170 of the original song 160 by creating the User-A content 220. The interactive music module 430 can enable the User-A to record, manipulate, mix, and build effects for any content stored in the song library 460.

The social music client 130 can include a user interface module 420 that can generate one or more user interfaces via a user interface mechanism 440 for a variety of interactive/social music functions.

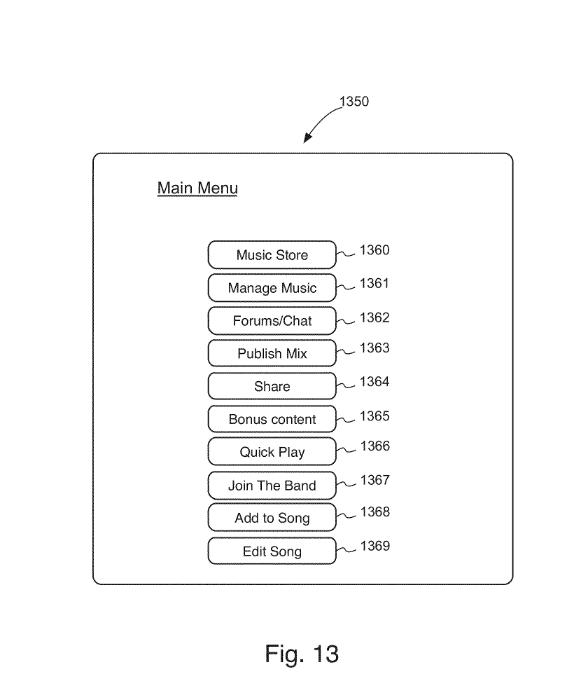

FIG. 13 illustrates a main menu 1350 in one or more embodiments of the social music client 130 that enables the User-A to access a variety of interactive and social music functions. The main menu 1350 includes a music store button 1360 that enables the User-A access the online music store 110 and the social music repository 120. The music store button 1360 can enable the User-A to stream original songs and social versions from the online music store 110 and the social music repository 120.

The main menu 1350 includes a manage music button 1361 that enables the User-A access and manage the original songs and social versions of original songs and the original and user content stored in the song library 460. The main menu 1350 includes a forums/chat button 1362 that enables the User-A to access the message board 1030. The forums/chat button 1362 can enable the User-A to read messages from the message board 1030 and post messages to the message board 1030.

The main menu 1350 includes a publish mix button 1363 that enables the User-A to post, i.e. publish, User-A content and social versions of original songs to the social music repository 120. The publish mix button 1363 can enable the User-A to edit ownership information for the ownership registry 150, e.g. security IP information. The main menu 1350 includes a share button 1364 that enables the User-A to share User-A content with other users. For example, the share button 1364 can enable the User-A to post content to a media site or application accessible to the public, e.g. YouTube.

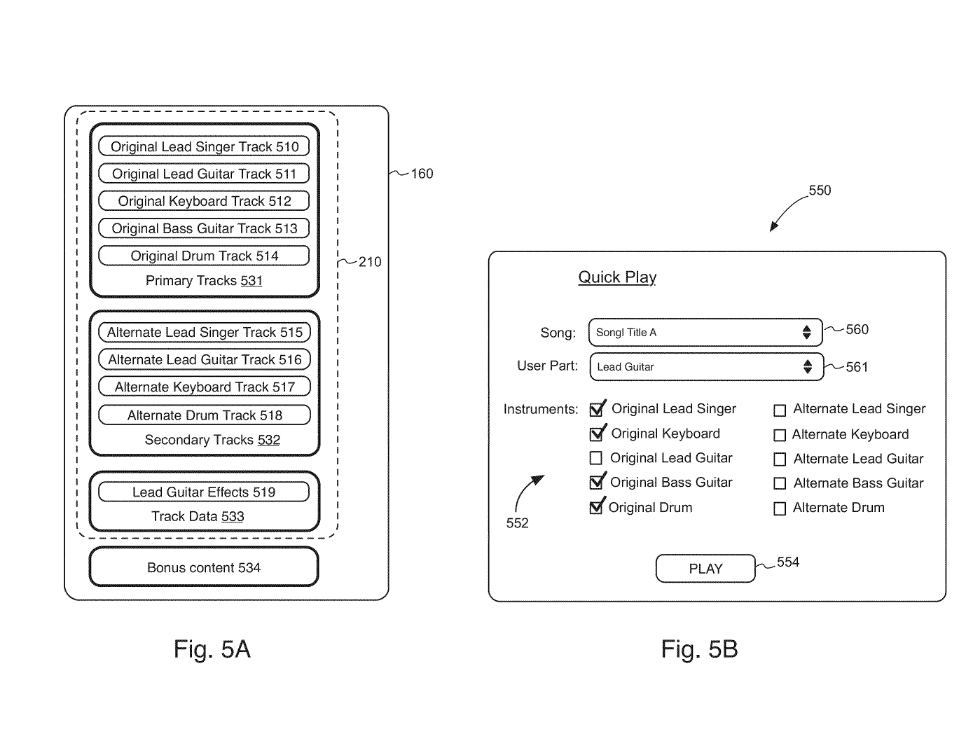

The main menu 1350 includes a bonus content button 1365 that enables the User-A to access the bonus content in the song library, e.g. the bonus content 534 of the original song 160. The main menu 1350 includes a quick play button 1366 that accesses the quick play user interface 550 (FIG. 5B). The main menu 1350 includes a “join the band” button 1367 that enables the User-A to access the music editing functions of the interactive music module 430. The music editing functions can include calibrating/tuning an instrument, learning a song or track of a song, selecting accompaniment and playing along with the band, as well as adding alternate tracks, effects, mixes, etc., to a social version of an original song.

The main menu 1350 includes an add to song button 1368 and an edit song button 1369 that enable the User-A to access menus for selecting original songs and social versions in the song library 460 and for creating social versions of the accessed songs.

The social music client 130 includes a sound subsystem 450 for generating playback audio for the User-A. The user interface mechanism 440 can include hardware and software components of a platform upon which the social music client 130 is implemented, e.g., keyboard, display, touchscreen, etc. of a mobile device, game console, personal computer. Similarly, the sound subsystem 450 can include sound hardware and software components of a platform. The sound subsystem 450 can include internal stereo speakers or mechanisms for driving external stereo speakers, headphones, etc.

FIG. 5A illustrates the original content 210 of the original song 160 in one example. The original content 210 include a set of primary tracks 531, a set of secondary tracks 532, and a set of track data 533. In one or more embodiments, the original song 160 can include a set of bonus content 534 pertaining to the original song 160.

The primary tracks 531 in this example include an original lead singer track 510, an original lead guitar track 511, an original keyboard track 512, an original bass guitar track 513, and an original drum track 514. The primary tracks 531 can be tracks made by an artist/producer of the original song 160 during the original recording session, e.g., the master track for publishing the original song 160. The primary tracks 531 can contain digital audio data in any audio format (e.g., an industry standard audio data format for the recording industry or consumer electronics industry).

The secondary tracks 532 in this example include an alternate lead singer track 515, an alternate lead guitar track 516, an alternate keyboard track 517, and an alternate drum track 518. The secondary tracks 532 can be tracks made by an artist/producer during the original recording session for the original song 160. The secondary tracks 532 can be tracks made by an artist/producer at another time. The secondary tracks 532 can include different takes in the recording process by the same artist/producer, a guest artist who performs a particular track, a back-up vocalist performing a duet with the original singer, to name a few examples. The secondary tracks 532 can include digital audio data in any audio format.

The track data 533 can enable the social music client 130 to apply audio effects to any of the primary tracks 531 or secondary tracks 532 or any content created by the User-A. The track data 533 can include timing information that enables effects to be synced to any part of a track. The audio effects can be used to recreate aspects of an original recording. The track data 533 can include playback parameters, e.g., output volume parameters, reverb/distortion parameters, pitch parameters, for any of the primary tracks 531 or the secondary tracks 532 or User-A content that replace or supplement the primary tracks or the secondary tracks 532. The track data 533 can include lyrics for any of the primary tracks 531 or the secondary tracks 532.

The track data 533 in this example includes a set of lead guitar effects 519 including volume, pitch, and reverb parameters. The lead guitar effects 519 enable the social music client 130 to adapt a lead guitar performance by the User-A to the original band recording of the original song 160.

The bonus content 534 can include any type of media pertaining to the original song 160. Examples of the bonus content 534 include facts and figures pertaining to the original song 160, commentary pertaining to the original song 160, photographs, video, including limited editions, pertaining to the original song 160 or the artist of the original song 160. The social music client 130 can present the bonus content 534 to the User-A via the user interface module 420 and user interface mechanism 440 for video and visual presentation and the interactive music module 430 can present audio of the bonus content 534 via sound subsystem 450.

FIG. 5B shows a user interface 550 in one or more embodiments that enables the User-A to quickly setup a custom accompaniment for recording a user performance for inclusion in the User-A content 220 of the social version 170. The user interface module 420 can generate the user interface 550 via the user interface mechanism 440. The user interface 550 can be accessed by the User-A via a quick play button 1366 on the main menu 1350.

The user interface 550 includes a popup list 560 that can enable the User-A to select the song title “Song Title A” that corresponds to the original song 160 in the song library 460. The user interface 550 includes a popup list 561 that can enable the User-A to select a part for the User-A to play for recording a user track. In this example, the User-A selects the lead guitar via the popup list 561. The popup list 561 can enable the User-A to select any voice or instrument or voice/instrument combination component of the song selected in the popup list 560 to play or sing or both.

The user interface 550 includes a set of checkboxes 552 that enable the User-A to select a set of components of the song selected in the popup list 560 for an accompaniment. Other menu mechanisms may be used to select accompaniment. In this example, the user has selected the Original Lead Singer, Original Keyboard, Original Bass Guitar, and Original Drum tracks for inclusion, i.e. an original band backing. The user interface 550 includes a play button 554 that enables the User-A to play the custom accompaniment selected via the checkboxes 552.

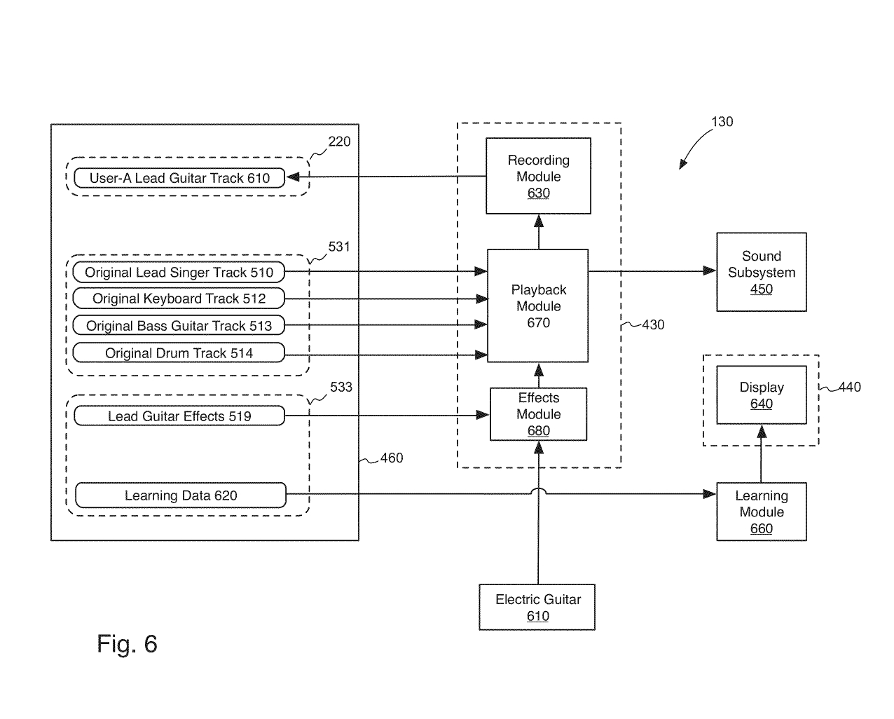

FIG. 6 illustrates the social music client 130 recording a User-A lead guitar track 610 with the custom accompaniment selected by the User-A via the user interface 550. In this example, the User-A plays the lead guitar part using an electric guitar 610. The interactive music module 430 includes an effects module 680 that can apply effects, e.g., pitch and reverb, to the performance by the User-A in response to the lead guitar effects 519 of the track data 533 of the original song 160.

The electric guitar 610 can be plugged into an audio input jack of the social music client 130 and the social music client 130 can digitize the input signal from the electric guitar 610. If the User-A plays an acoustic guitar then the acoustic signal can be recorded using an internal microphone in the social music client 130 or a microphone connected to the social music client 130 via a line-in connector.

The interactive music module 430 includes a playback module 670 that generates an accompaniment specified by the User-A via the user interface 550 through the sound system 450 by mixing the original lead singer track 510, the original keyboard track 512, the original bass guitar track 513, and the original drum track 514 of the original song 160. The interactive music module 430 can also mix in the input from the electric guitar 610 including the effects provided by the effects module 680 for playback through the sound subsystem 450.

The interactive music module 430 includes a recording module 630 that generates a digital recording of the User-A performance and stores it with the User-A content 220 as the User-A lead guitar track 610. The User-A lead guitar track 610 can then be posted to the social music repository 120 with the social version 170. The User-A lead guitar track 610 can replace an existing track in the social version 170, e.g., one of the primary or secondary tracks copied over from the original song 160, or can supplement the existing tracks in the social version 170.

The User-A lead guitar track 610 can be stored separately from the social version 170 in the song library 460 and used like any other content in the song library 460, e.g., it can be selected via popup lists in the user interface 550 or another user interface to generate a custom mix or when recording another user track or when constructing social versions of songs in the song library 460. The User-A lead guitar track 610 can be stored in the song library 460 as a single track and mixed with any other individual tracks or tracks contained in originals songs or social versions stored in the song library 460.

The lead guitar effects 519 can be the effects for the original lead guitar track 511. The audio effects applied by the effects module 680 can enable the social music client 130 to assist the User-A in sounding as close to the sound of the original artist as is desired by the User-A. The user interface module 420 can enable the user to select the audio effects to be applied or to disable audio effects. In some embodiments, the lead guitar effects 519 can be generated by the User-A and the User-A effects can include in the social version 170, e.g., the User-A can include effects in the User-A content 220 of the social version 170.

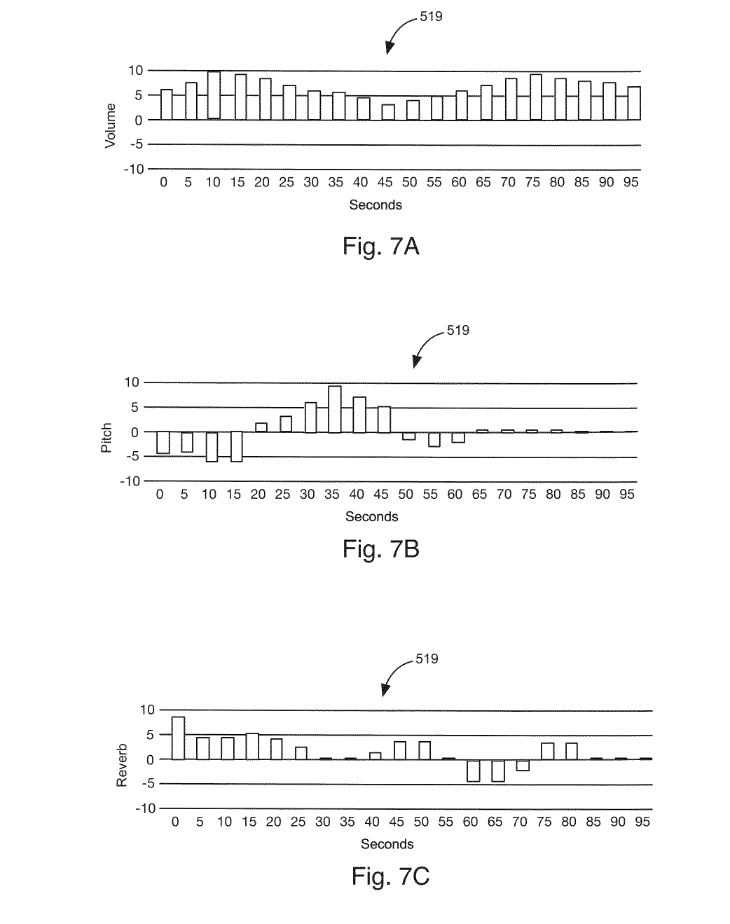

FIGS. 7A-7C illustrate examples of the lead guitar effects 519. The lead guitar effects 519 in this example include volume, pitch, and reverb parameters. The volume parameters of the lead guitar effects 519 are shown in FIG. 7A. The pitch parameters of the lead guitar effects 519 are shown in FIG. 7B. The reverb parameters of the lead guitar effects 519 are shown in FIG. 7C. The time axes for the effects can correspond to the play time for the original song 160.

Referring back to FIG. 6, the social music client 130 includes a learning module 660 that assists the User-A performance by displaying playback cues and learning cues on a display 640 of the user interface mechanism 440 in response to a set of learning data 620 included in the track data 533. The cues displayed on the display 640 can take any form. A playback cue on the display 640 can be as simple as a countdown to the start of a song. A playback cue can include guide notes, chords, sheet music, instructional materials, etc.

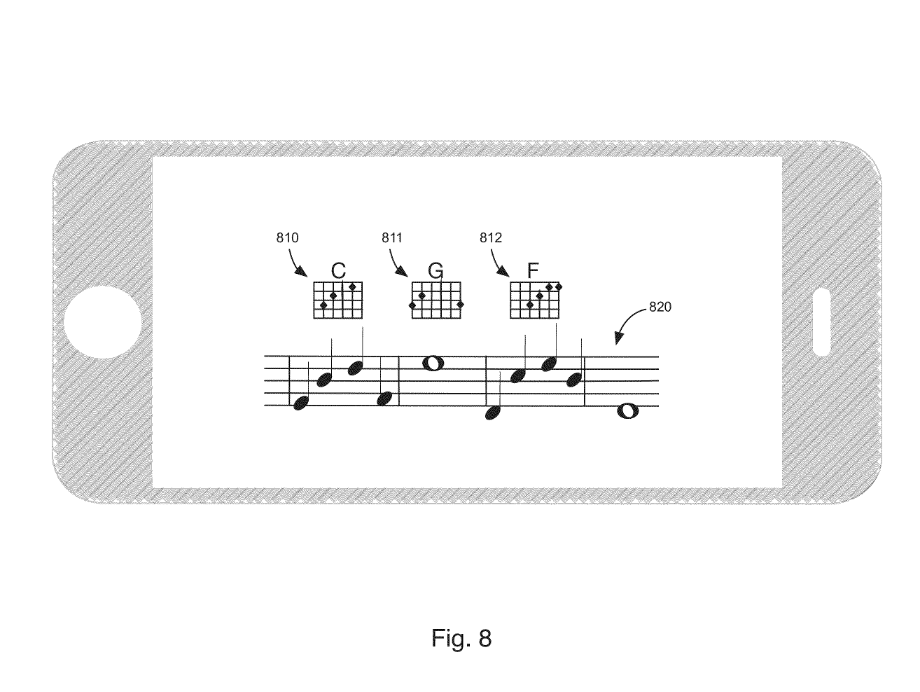

FIG. 8 shows examples of learning cues provided on the display 640 in one or more embodiments. In this example, learning cues include a sheet music line 820 and a corresponding series of chord charts 810-812. A set of sheet music images with chord charts can be stored with the learning data 620 and the learning module 660 can scroll through the sheet music for the display 640 in time with the playback of one or more components the original song 160 selected by the User-A. Other examples of learning cues that may be provided on the display 640 are illustrations of guitar finger positions.

The learning data 620 can be distributed by the publisher of the original song 160. The learning data 620 can be purchased after purchase of the original song 160 and stored along with the track data 533 by the social music client 130. The learning data 620 can be generated by the User-A or another user and can be added as user content to a social version of an original song, e.g., the User-A can include learning data in the User-A content 220 of the social version 170.

In one or more embodiments, the social music client 130 can provide a learning mode, selectable via a user interface generated by the user interface module 420, in which the interactive music module 430 first plays a whole song while the learning module 660 plays visual aids for the song (e.g., by scrolling through sheet music on the display 640). The interactive music module 430 then plays the whole song again while the learning module 660 provides guidance notes on the display 640. The interactive music module 430 then plays a discrete track (e.g., lead guitar) in sections and then plays other components of the song, e.g., backing music, etc. In one or more embodiments, the social music client 130 enables the User-A to engage in a learning process for a selected song or track prior to the recording a User-A performance for that song or track. The learning data 620 and the effects 519 can be adapted by users to learning and playing a song other than as originally recorded by an original artist.

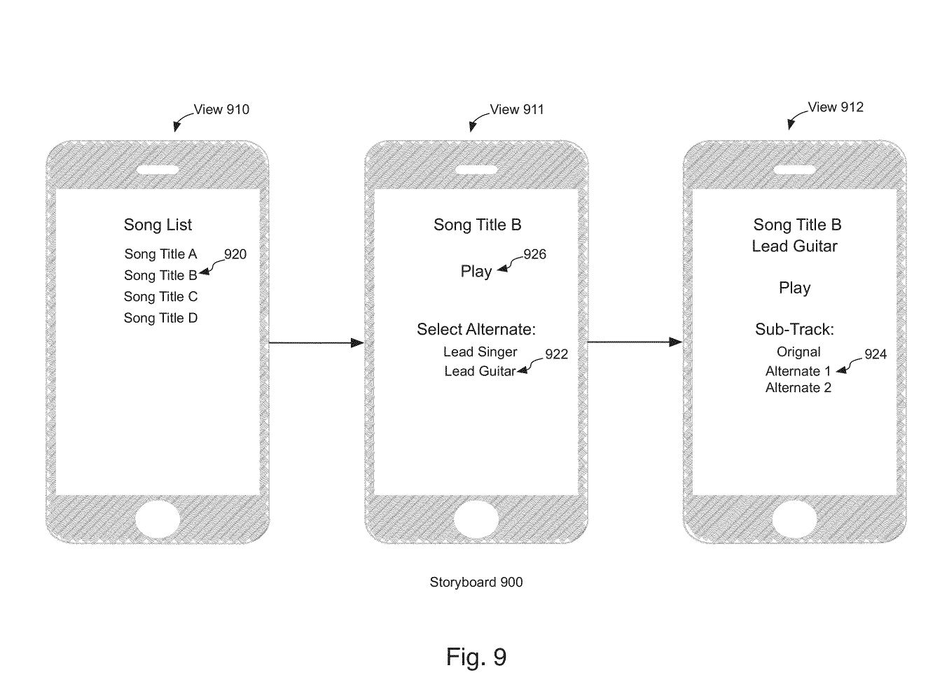

FIG. 9 shows a storyboard 900 for a user interface in one or more embodiments of the social music client 130 that enables the User-A to create a custom mix for playback. The storyboard 900 can be displayed by, e.g., a touch-screen mobile device. The storyboard 900 provides a series of interactive touch-screen views 910-912 that enable the User-A to select and play a song stored in the song library 460 and select alternate content of the selected song.

The view 910 displays a Song List by song name, which includes a set of songs (Song Titles A-D) stored in the song library 460. The view 910 includes selector user interface elements (UI elements) that enable the User-A to touch corresponding areas of the view 910 to select the Song Titles A-D individually. In this example, the user touches an area 920 of the view 910 to select the Song Title B stored in the song library 460.

The storyboard 900 transitions from the view 910 to the view 911 when the user touches the area 920 in the view 910. The view 911 includes a Play button corresponding to an area 926 of the view 911 and a “Select Alternate:” list that provide a list of components of Song Title B for which the user may select an alternate. In this example, the user touches an area 922 of the view 911 to select an alternate lead guitar track of Song Title B.

The storyboard 900 transitions from the view 911 to the view 912 when the user touches the area 922 in the view 911. The view 912 includes the Play button corresponding to the area 926 of the view 911. The view 912 includes a “Lead Guitar” label below the Song Title B label indicating that the user is selecting a lead guitar track. The view 912 includes “Sub-Track:” list that provides a list of available lead guitar tracks—Original, Alternate 1 or Alternate 2, among which the User-A can select. In this example, the user touches an area 924 of the view 912 to select Alternate 1. The playback module 670 generates a playback through the sound subsystem 450 by mixing the selected Alternate 1 track with the default primary tracks of Song Title B.

The storyboard 900 can transition to a playback view (not shown in FIG. 9) when a user touches the area 926 in the view 911 or the corresponding area in the view 912 for the Play button or when the user touches the area 924 in the view 912. A playback view can provide audio playback controls (e.g., start, stop, pause, volume, equalizer, etc.) and can provide other information (e.g., album covers, artwork, alternate tracks used, etc.) or display media from the corresponding bonus content distributed with the corresponding original song.

The social music client 130 can enable a user to create there own custom song mix and store it as a normal digital music file that can be played with a conventional music player. For example, a mix generated by the interactive music module 430 for playback on the sound subsystem 450 can be recorded by the recording module 630 and stored in the song library 460 or another song library as an mp3 file or a digital music file according to another industry standard format. If the source of the custom mix, e.g. the original song 160, is copy protected then the digital music file with the custom mix can have the same copy protection.

In one or more embodiments, the social music client 130 includes a calibration mode, selectable via a user interface generated by the user interface module 420, that can enable a user to calibrate their instrument or calibrate a song to a user's voice. For example, the calibration mode can assist a user with tuning of an instrument to match the pitch of a particular song or adjust the pitch of a song to match the tuning of the instrument.

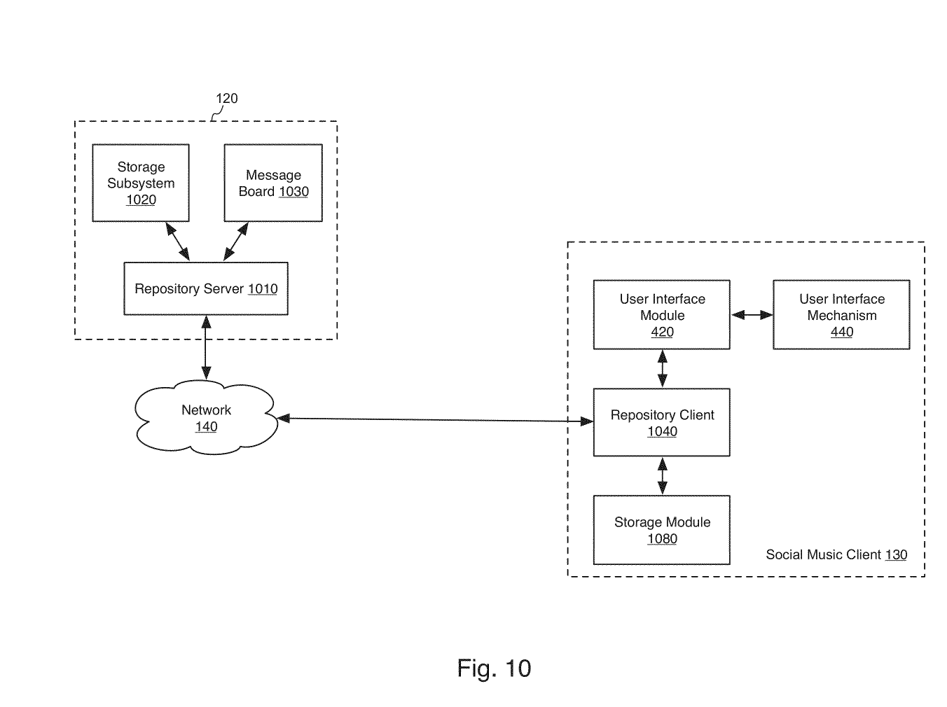

FIG. 10 shows communication between the social music client 130 and the social music repository 120 in one or more embodiments. The social music repository 120 includes a repository server 1010 that provides access to information in a storage subsystem 1020. For example, the inventory 126 of social versions can be held in the storage subsystem 1020 by the repository server 1010.

The social music repository 120 includes a message board 1030 that is accessible via the repository server 1010. The message board 1030 can enable discussions among the users of the social music clients 130-132 about original songs and social versions of original songs, and can enable the users of the social music clients 130-132 to discuss songs, follow artists, receive alerts, etc. The message board 1030 can provide a chat forum or similar forum to the User-A of the social music client 130, and to the User-B and the User-C of the social music clients 131-132. A chat forum can enable user discussions specifically in relation to the social versions held in social music repository 120, e.g. the social version 170. User discussions can include discussions of user performances in social versions and discussions pertaining to the original artist associated with social versions. Original artists can also post in the user discussion forums in the social music repository 120, thus providing an additional marketing channel for their work.

Each participant, e.g., artist or user of the social music clients 130-132, in the message board 1030 can have a distinct identity. The distinct identity can enable each participant to create their own sub-forums (similar to a social media page). An identity may also allow a participant to claim a status, e.g. a status attributable to their identity. For example, a status may be determined by determining a number of sales, views or listens of tracks in a social version to which the corresponding participant has contributed. A status may be apportioned by the particular contribution of the corresponding participant to the corresponding social version as indicated in the ownership registry 150.

In one or more embodiments, the social music client 130 includes a repository client 1040 for communicating with the repository server 1010. The repository client 1040 can enable the social music client 130 to post social versions, e.g., the social version 170, to the repository server 120. The repository client 1040 can enable the User-A of the social music client 130 to access the message board 1030 using the user interface module 420 and the user interface mechanism 440.

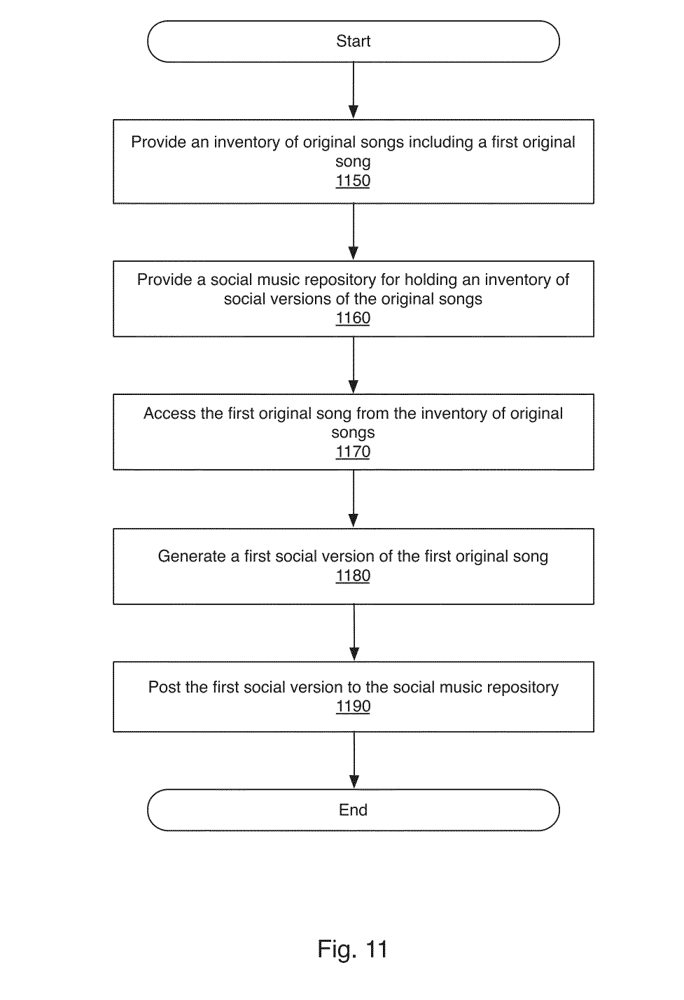

FIG. 11 shows a method for social music in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 11 should not be construed as limiting the scope of the invention.

At step 1150, an inventory of original songs is provided, including a first original song. The inventory of original songs can be made accessible via a network, e.g. using web protocols. The inventory can include any number of original songs published by original producer/artists.

At step 1160, a social music repository is provided for holding an inventory of social versions of the original songs. The social music repository can be made accessible via a network, e.g. using web protocols. The social music repository can include any number of social versions of original songs created by users. The social music repository can be a component of an online music store or may be a separate entity, e.g., a separate web site.

At step 1170, the first original song is accessed from the inventory of original songs. For example, a user may access the first original song using their own social music client, e.g., a handheld or other type of device. Step 1170 can include purchasing the first original song from an online music store.

At step 1180, a first social version of the first original song is generated. For example, a user of a social music client may use their social music client to generate the first social version by generating a user track and adding the user track to the tracks contained in the first original song. Step 1180 can include substituting a user track for one or more of the tracks contained in the first original song.

At step 1190, the first social version is posted to the social music repository. For example, a user may post the first social version to the social music repository using their own social music client, e.g., a handheld or other type of device. The first social version once posted in the social music repository can be accessed, e.g., via streaming or download/purchase. The first social version in the social music repository can form the basis for creating additional social versions of the first original song.

Embodiments of the invention may be implemented on a specialized computer system. Examples of such a computing system can include one or more mobile devices (e.g., laptop computer, smart phone, personal digital assistant, tablet computer, or other mobile device, game console), desktop computers, servers, blades in a server chassis, or any other type of computing device(s) that include at least the minimum processing power, memory, and input and output device(s) to perform one or more embodiments of the invention.

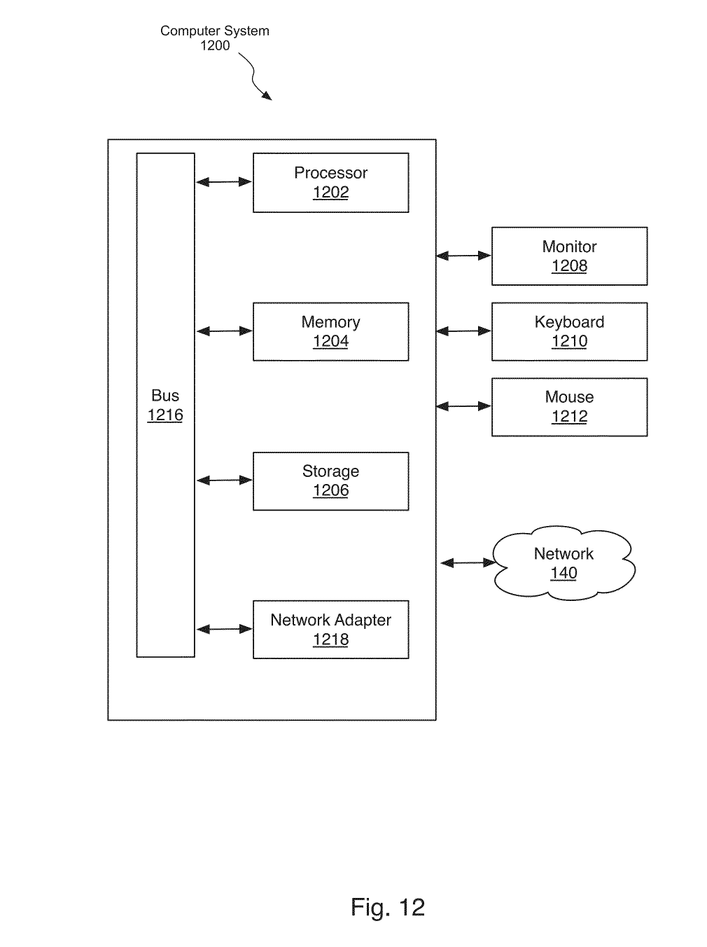

FIG. 12 illustrates a computing system 1200 that may include one or more computer processor(s) 1202, associated memory 1204 (e.g., random access memory (RAM), cache memory, flash memory, etc.), one or more storage device(s) 1206 (e.g., a hard disk, an optical drive such as a compact disk (CD) drive or digital versatile disk (DVD) drive, a flash memory stick, etc.), a bus 1216, and numerous other elements and functionalities. The computer processor(s) 1202 may be an integrated circuit for processing instructions. For example, the computer processor(s) may be one or more cores or micro-cores of a processor. The computing system 1200 may also include one or more input device(s), e.g., a touchscreen, keyboard 1210, mouse 1212, microphone, touchpad, electronic pen, or any other type of input device. Further, the computing system 1200 may include one or more output device(s) 1208, such as a screen (e.g., a liquid crystal display (LCD), a plasma display, touchscreen, cathode ray tube (CRT) monitor, projector, or other display device), external storage, input for an electric instrument, or any other output device. The computing system 1200 may be connected to the network 140 (e.g., a local area network (LAN), a wide area network (WAN) such as the Internet, mobile network, or any other type of network) via a network adapter 1218.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A social music system, comprising:
an online music store for holding an inventory of original songs, the online music store enabling a set of social music clients to access the original songs and generate a set of social versions of the original songs;
a social music repository for holding an inventory of the social versions, the social music repository enabling the social music clients to post the social versions and access the posted social versions; and
an ownership registry for holding a set of ownership information for each social version in the social version repository such that the ownership information enables allocation of ownership among a set of original artists of the original songs and a set of users of the social music clients.

2. The social music system of claim 1, wherein one or more of the original songs in the online music store includes a set of original content and a set of original effects applied to the original content.

3. The social music system of claim 1, wherein one or more of the original songs in the online music store includes a set of original content and a set of learning data pertaining to the original content.

4. The social music system of claim 1, wherein one or more of the original songs in the online music store includes a set of original content and a set of bonus content pertaining to the original content.

5. The social music system of claim 1, wherein the social music repository enables the users of the social music clients to purchase access to the social versions.

6. The social music system of claim 1, wherein each set of ownership information comprises an ownership identifier for each set of content in the corresponding social version.

7. The social music system of claim 6, wherein at least one of the ownership identifiers corresponds to an original artist of the corresponding original song.

8. The social music system of claim 6, wherein at least one of the ownership identifiers corresponds to one of the users of one of the social music clients.

9. The social music system of claim 1, further comprising a message board that enables communication pertaining to the original songs and the social versions among the original artists and the users of the social music clients.

10. A social music client, comprising:
a song library for holding a first original song obtained from an online music store;
an interactive music module that enables a user to generate a social version of the first original song by creating a set of user content for the social version in response to a set of original content of the first original song; and
a repository client that enables the user to post the social version of the first original song to a social music repository.

11. The social music client of claim 10, wherein the song library holds a first social version of a second original song in the online music store and the interactive music module enables the user to generate a second social version of the second original song by creating a second set of user content for the second social version in response to a set of content of the first social version of the second original song.

12. The social music client of claim 11, wherein the repository client enables the user to post the second social version of the second original song to the social music repository.

13. The social music client of claim 10, wherein the interactive music module enables the user to apply a set of effects to the user content in response to a set of effects in the first original song.

14. The social music client of claim 10, wherein the interactive music module enables the user to create a custom mix of the original content and the user content.

15. The social music client of claim 10, wherein the interactive music module enables the user to select an accompaniment for a user performance from among the original content and the user content.

16. The social music client of claim 10, further comprising a learning module that generates a set of learning cues for assisting the user in learning the original content in response to a set of learning data included in the first original song.

17. The social music client of claim 10, further comprising:
recording module for recording a performance by the user; and
effects module for applying a set of original effects to the performance in response to a set of effects contained in the first original song.

18. A method for social music, comprising:
providing an inventory of original songs including a first original song;
providing a social music repository for holding an inventory of social versions of the original songs;
accessing the first original song from the inventory of original songs;
generating a first social version of the first original song; and
posting the first social version to the social music repository.

19. The method of claim 18, further comprising:
accessing the first social version from the social music repository;
generating a second social version of the first original song in response to the first social version; and
posting the second social version to the social music repository.

20. The method of claim 18, further comprising:
registering a set of ownership information for the first social version in the social version repository; and
allocating pecuniary remuneration for the first social version in response to the ownership information.
